(19) United States
(12) Patent Application Publication
(10) Pub. No.: US 2026/0336716 A1
(43) Pub. Date: Oct. 29, 2026

(54) MUD FLAP MOUNTING ASSEMBLY AND SYSTEM FOR TOW HITCH CHANNEL MOUNT

(71) Applicant: Advanced Engineering Group, LLC, Valencia, CA (US)

(72) Inventors: Bryan Fletcher, Valencia, CA (US); Jeffrey Allen Good, Cayucos, CA (US)

(73) Assignee: Advanced Engineering Group, LLC, Valencia, CA (US)

(21) Appl. No.: 19/188,002

(22) Filed: Apr. 24, 2025

(51) Int. Cl. B62D 25/18

(52) U.S. Cl. CPC B62D 25/182

(57) ABSTRACT

A mounting assembly and system designed for secure, height adjustable attachment of a mud flap to a tow hitch channel mount on a rear of a vehicle enabling simultaneous height adjustable attachment of a tow accessory receiver to the tow hitch channel mount, the mounting assembly having a pair of inverted L-shape brackets including opposed arm members and downwardly disposed leg members disposed in stationary alignment on a single cross-sectional or Cartesian plane and coupled within receiving tubes with side flanges fastened through aligned corresponding aligned pairs of side holes are interfaced with dampening spacers, and upper edges of the mud flaps are affixed to the arm members.

### FIELD OF THE INVENTION

The subject invention relates to a mounting assembly and system for height adjustable attachment of a mud flap to a tow hitch channel mount on a rear of vehicle.

### BACKGROUND OF THE INVENTION

The use of mud flaps to protect vehicles, trailers or other accessories from road debris, water, and mud splatter that soils and can cause damage to the towed trailer or accessory and or surrounding vehicles is widely known. Existing mud flap mounting mechanisms for attachment to tow hitch assemblies typically bolted to tow mount shank receivers provide splatter protection have shortcomings such as, for example, lack of stability, durability and height adaptability, persist.

Among other drawbacks and limitations, one disadvantage of multi-component mud flap mounting devices bolted to shank receivers ensues from vibration and rattle emitted by the multiple parts and bolts. That is, the friction caused by the motion of the trailer or other tow accessory frame and support flanges exacerbates noise and vibration emitted with tow-related movement.

A further drawback of conventional mud flap devices is the lack of height adjustability particularly relative to a towed trailer or accessory mounted on a tow hitch assembly. Adjusting height of mud flaps is desirable in order to adapt to road conditions and load and thereby enhance performance of such mud flaps. That is, road conditions are accommodated by lowering the mud flaps on smooth roads and elevating them on rough trails to clear variable heights of ruts, roots, rocks and such. Adjusting height of the mud flaps further facilitates adjustment to heavier loads weighing down a trailer by raising the flaps to accommodate reduced vehicle and/or trailer height and lowering the flaps with lighter loads.

Conventional mud flap systems incorporating axial rotation mechanisms providing vertical adjustability lack the durability and adaptive capacity for height adjustability of both the tow mount receiving member and mud flaps. That is, conventional tow and mud flap assemblies lack a system for simultaneously lowering a hitch ball while raising mud flaps to accommodate a heavy load, i.e., a mud flap support system taught in U.S. Pat. No. 6,076,842 deploys cross members connected to a pivoting hub attached to a U-bracket on a shank receiver tube. While such devices provide height adjustability, the multiple components, particularly the moving parts of the pivoting mechanisms, are vulnerable to being damaged by road debris, mechanical impact damage and rust among other elements. Moreover, the device lacks a means for simultaneous adjustment of the height of the tow accessory receiver to adjust for road conditions or load of the towed trailer or mounted accessory.

Thus, until now, there remains a persisting need for a stable, durable mud flap mounting assembly and system that can be securely affixed to a tow hitch channel mount while reducing noise and vibration and allowing simultaneous height adjustability of the mud flaps and the towed trailer or mounted accessory.

### SUMMARY OF THE INVENTION

Various embodiments of the present invention provide a height adjustable mud flap mounting assembly and system configured for attachment to a tow hitch channel mount by selective coupling of at least one elongate pin through corresponding aligned pairs of side holes in opposed flanges perpendicularly extended from a recessed channel of the tow hitch channel mount and a through hole appended on a receiving tube securing a support member, i.e., a mounting bracket, whereto a mud flap is affixed. In many embodiments, a height adjustable tow receiver mount may be simultaneously deployed by concurrent selective coupling of the aligned pairs of side holes in the tow hitch channel mount opposed flanges and a through hole in a tow receiver mount support.

In various embodiments, the mud flap mounting device and system features at least one or a pair of inverted L-shaped support brackets with leg portions configured for parallel longitudinal alignment with the tow hitch channel mount and transverse arm portions extended at a substantially perpendicular angle from the upper end of the leg portion. In many embodiments, the leg portion and the arm portion are disposed on a single, stationary cross-sectional or Cartesian plane. In many embodiments, the lower section of the leg portion of the inverted L-shape support brackets are seated in a pair of receiving members configured for coupling with the lower section of the leg portion. Various embodiments further feature of such receiving members are perpendicularly disposed side flanges having at least one fastener hole.

In some embodiments, a fastener, being an elongate pin or bolt in some embodiments, is coupled through the fastener holes perpendicularly extended from receiving tubes flanking a tow hitch channel member and corresponding aligned pairs of side holes of the opposed flanges of the tow hitch channel. Thus securing the receiving members assembly flanked in abutted parallel alignment against transverse outer surfaces of the opposed flanges of the tow hitch channel member positions the leg portions of the Inverted L-shape bracket parallel to the longitudinal axis of the tow hitch channel member and the substantially perpendicularly opposed ends of the arm members in transverse linear alignment on a substantially horizontal axis. In the various embodiments, a pair of mud flaps are affixed on at least a portion of their upper ends to at least a corresponding portion of the arm members such that the mud flaps are downwardly disposed rear of the tires, thereby deflecting road debris and precipitation on the road from contacting a towed trailer or accessory.

Mud flaps in various embodiments may be secured or affixed to arm portions of the inverted L-shape brackets by various fastening mechanisms. Exemplary fastening mechanisms include bolts and corresponding nuts, thermal seals, adhesives, snap closures, magnetic clasps or other commercially available products. In some embodiments, binding members having a front surface and rear surface where between arm members and mud flaps may be secured between a front side and a rear side of the binding members.

Various embodiments further include, dampening spacers that may be provided as semi-rigid tabs with circular holes extending into ringed lips for insertion within the fastener holes and side holes averting gaps or movement and thereby stabilize coupled fasteners within the aligned side holes of the opposed flanges of the tow channel hitch. The semi-rigid material of the dampening spacers in various embodiments may be composed of nylon, rubber, polymer or elastomer including thermoplastics, polypropylene, polyvinyl chloride or any composition of natural or synthetic material(s) capable of attenuating movement between abutting surfaces of the fastener and fastener holes, side holes and adjacent surfaces of the side flanges of the receiving member or the opposed flanges of the tow hitch channel mount.

These and other features will be evident from the ensuing detailed descriptions of representative exemplary embodiment in view of the definitions set forth below and from the drawings.

As used herein, “tow hitch channel” refers to a column for height adjustable attachment of a tow receiver member by coupling of a fastener pin, such as a cotter pin, bolt or similar fastener with aligned side holes or through holes of a selected height.

As used herein, “tow receiver member” refers to a tow accessory or trailer receiver having an end portion with a receiving end featuring an accessory or trailer mounting mechanism such as a single ball, dual ball, pintle or other hook or other hitch receiver mount for coupling an independent trailer or towed accessory, including a trailer, carrier such as for bicycles or recreational equipment racks, ski carriers, storage decks, boxes cages or bags and other types of single or multi-hitch carriers or connectors. On an end opposite the receiver end of the “tow receiver member” is a base portion configured for detachable connection to the tow hitch channel with at least one through hole and more typically two through holes or two pairs of aligned side holes on upper or lower flanges for alignment with corresponding aligned paired side holes in flanges of the tow mount assembly for coupling an elongate pin or bolt.

As used herein, an “elongate pin” includes any fastener characterized by a rod end extended from a head. The rod end can be smooth or threaded along a portion or the entire surface. In alternative embodiment elongate pins may be cotter pins characterized by end holes for coupling corresponding clips.

As used herein, a “single cross-sectional plane” or “Cartesian plane” as applied to the inverted leg member is a two dimensional planar reference limited to single stationary x and y axes.

As used herein, “substantially perpendicular” refers to a right, 90 degree angle plus or minus 10 degrees and may therefore range between 80-100 degrees.

### BRIEF DESCRIPTION OF THE DRAWINGS

FIG. 1 is a front perspective view of an exemplary embodiment of the mud flap mounting assembly and a tow receiver member simultaneously attached to a tow hitch channel mount.

FIG. 2 is a rear perspective view of the exemplary embodiment of the mud flap mounting assembly attached to a tow hitch channel mount shown in FIG. 1.

FIG. 3 is a perspective view of and exemplary embodiment of the tow receiver mount shown apart from the assembled configuration of FIGS. 1 and 2.

FIG. 4 is an exploded view of an exemplary embodiment of the receiving tube and pair of insert members with two ringed lips shown in context of their placement in the aligned pairs of side holes of the opposed flanges tow hitch channel mount.

FIG. 5 is a close-up view of the inserts with two ringed lips shown coupled with corresponding side holes of the opposed flanges of the tow hitch channel mount shown in FIG. 4.

FIG. 6 is a close-up left side perspective view of the receiving tubes fastener holes aligned with side holes of the opposed flanges of the tow channel mount.

FIG. 7 is a close-up right side perspective view including the bolts securing the aligned fastener of the side flange and side holes of the opposed flanges of the tow channel hitch shown in FIG. 5.

FIG. 8 is a close-up left side perspective view of FIG. 5 illustrating the corresponding nuts secured against the side flange of the receiving tube to opposed flanges of the tow channel hitch.

FIG. 9 is a front perspective view of the mud flap bolts securing the aligned fastener of the side flange and side holes of the opposed flanges of the tow channel hitch.

### DETAILED DESCRIPTION OF EXEMPLARY EMBODIMENTS

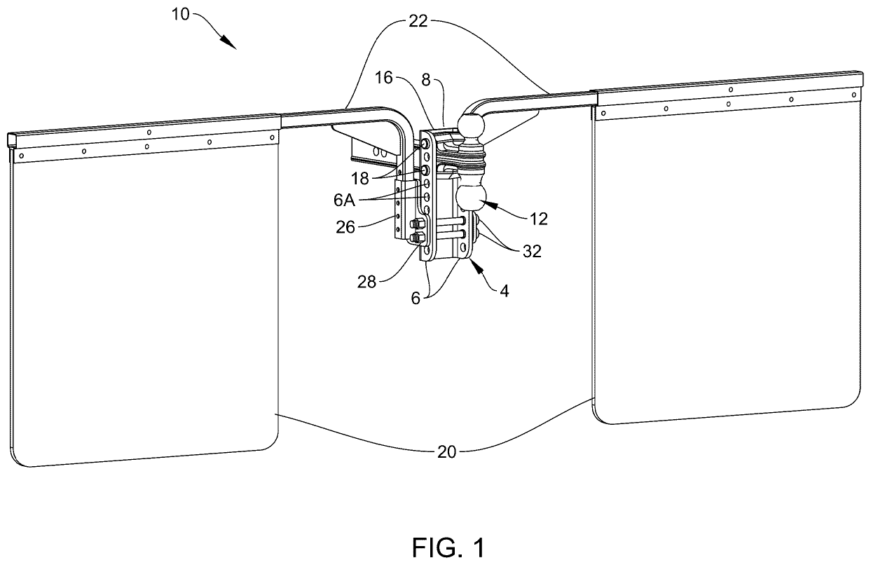

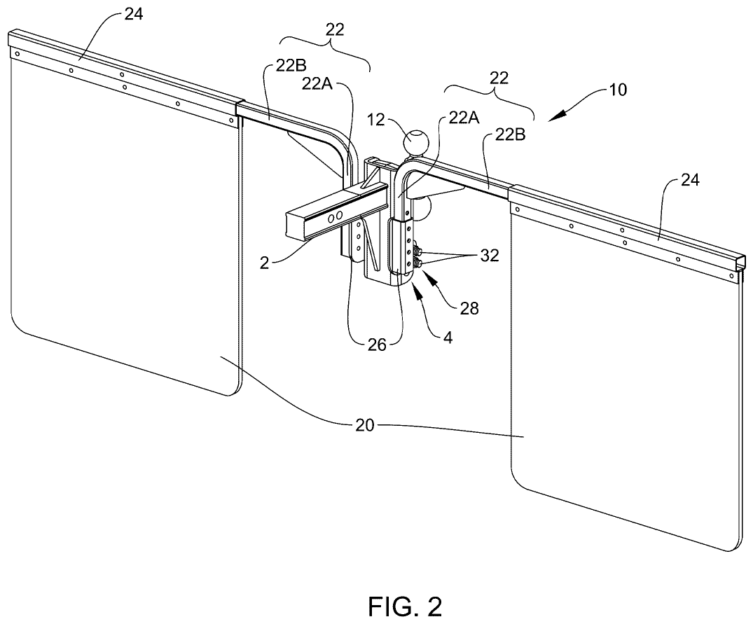

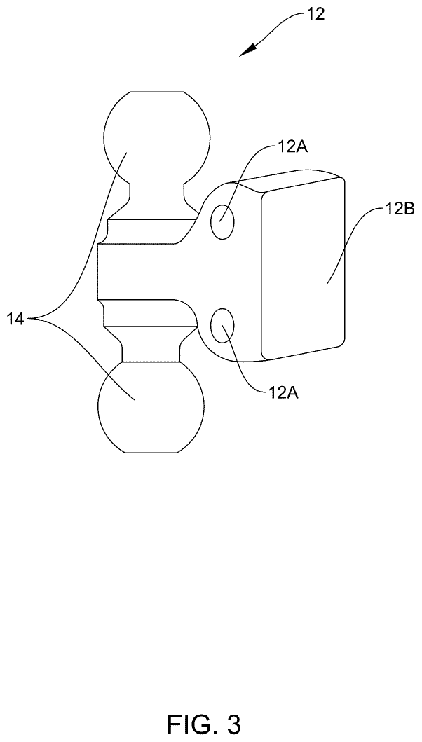

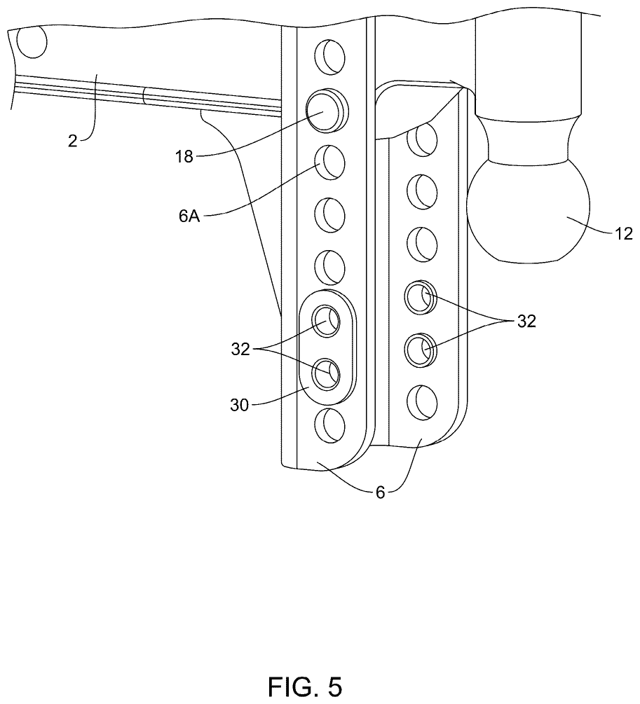

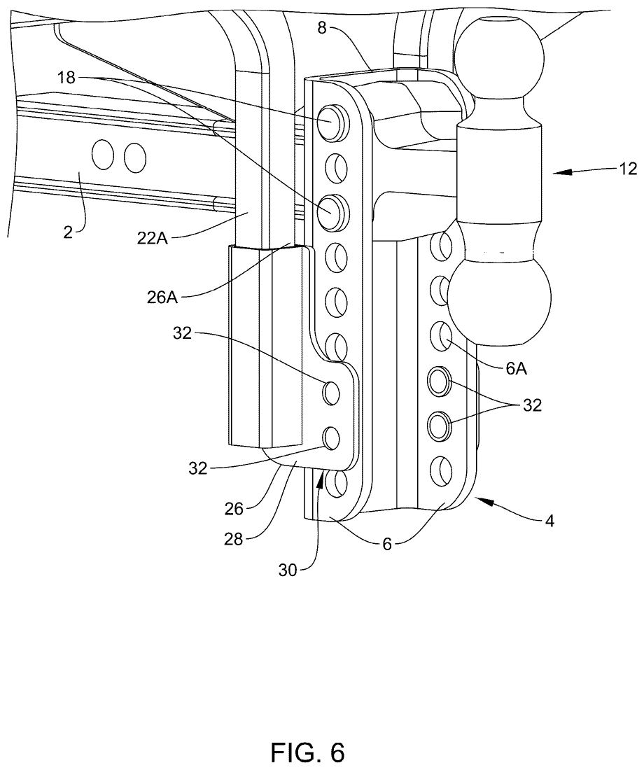

An exemplary embodiment of the present invention illustrated in FIG. 1-9 is drawn toward a height adjustable mud flap mounting assembly 10 and system configured for attachment to a tow hitch channel mount 4. As shown in FIGS. 1 and 2, tow hitch channel mount 4 is couplable to tow receiver member 12 by selective insertion of elongate pins 18 through corresponding aligned pairs of side holes 6A in opposed flanges 6 perpendicularly extended from a recessed channel 8 of tow hitch channel mount 4 and through holes 12A disposed within support base 12B of tow receiver member 12. Such selective coupling of elongate pins 18 enables height adjustability of dual balls 14, shown as a separate component apart from the mud flap assembly in FIG. 3, in order to adapt to relevant loads and road conditions.

Still referring to FIGS. 1 and 2, mud flap mounting assembly 10 includes a pair of inverted L-shape brackets 22, each with a leg portion 22A having a lower end and an upper end wherefrom arm portion 22B is disposed at a substantially perpendicular angle from the upper end of the leg portions 22A. Embodiments such as illustrated in the illustrated exemplary embodiment feature leg portions 22A configured for parallel longitudinal alignment with the tow hitch channel mount 4 and disposed such that arm portions 22B extend transversely from upper ends of leg portions 22A on a stationary single cross-sectional, Cartesian plane, providing a stable structure for mounting mud flaps 20.

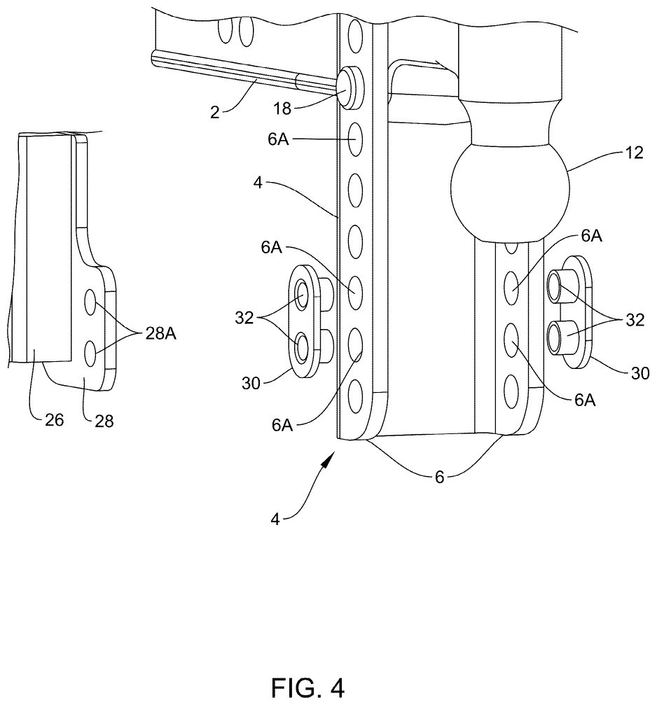

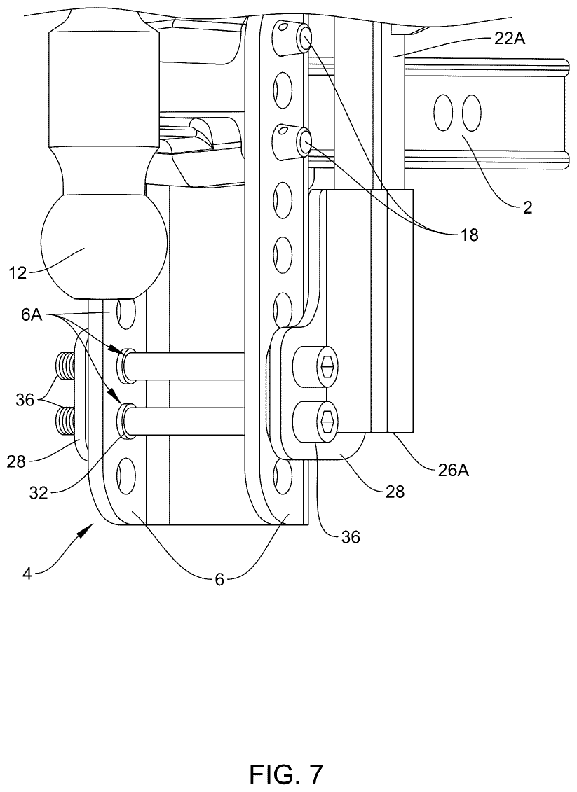

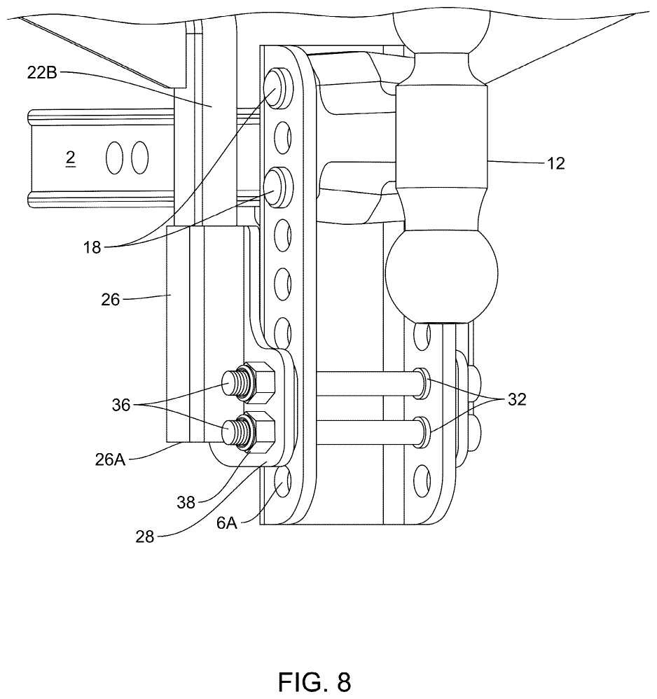

As further shown in FIGS. 1-2, receiving tubes 26 are configured to receive at least a lower section of the corresponding leg portion 22A. Now referring to FIG. 4-8, perpendicularly disposed inwardly from a sidewall of receiving tubes 26 are side flanges 28 wherethrough two fastener holes 28A are disposed. As best shown in FIGS. 7 and 8, coupling of bolts or elongate pins 32 through aligned fastener holes 28A and side holes 6A on the opposed flanges of tow hitch channel mount 4 locks leg portions 22A of inverted L-shape brackets 22 within respective receiving tubes 26 such that arm portions 22B are secured in opposed parallel alignment.

Again referring to FIGS. 1, 2, mud flaps 20 are attached to arm portions 22B of inverted L-shaped brackets 22 by attachment of their upper edges to binding members 24 mounted on arm portions 22B.

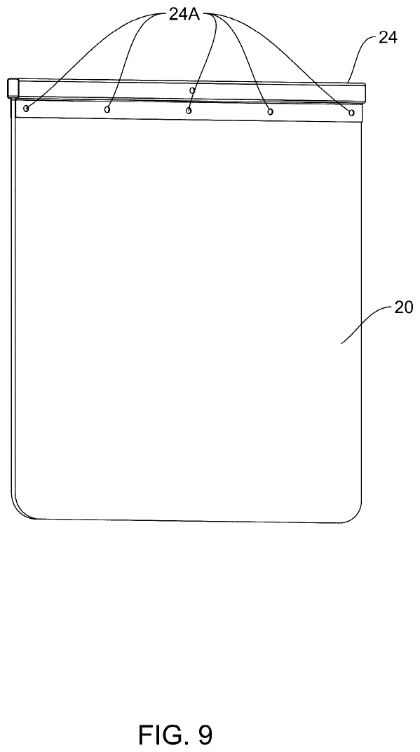

Now referring to FIG. 9, various embodiments include mud flaps 20 attached by binding members 24. In some embodiments, front and rear sides of binding members 24 are secured by binding fasteners 24A. In various alternative embodiments, binding fasteners 24A may be bolts and corresponding nuts, snap closures, an adhesive, thermal seaming, or magnetic clasps. This ensures a durable and adjustable attachment, allowing customization based on the user's preferences.

As shown, fasteners 36 illustrated as bolts or elongate pins featuring threaded ends secure receiving tubes 26 and inverted L-shape brackets 22 between coextensive outer surfaces of opposed flanges 6 of tow hitch channel mount 4. Alternative embodiments may employ fasteners or fastening mechanisms configured as U pins or pairs of elongate pins 32 or other commercially available fastener mechanisms providing a secure and stable connection between tow hitch channel mount 4 and receiving tubes 26. In some embodiment, a commercially available locking closure mechanism secures leg members 22 within receiving tubes 26.

As illustrated in FIG. 9, mud flaps 20 are affixable to arm portions 22B of inverted L-shape brackets 22 by securing at least portions of their upper edges to arm portions 22B with fasteners 20A. Various embodiments, such as illustrated in FIGS. 1, 2 and 9, may employ binding members 24 having front and rear sides disposed on corresponding upper edges of mud flaps 20. Variable commercially available fasteners may be employed to thus attach mud flaps 20 to L-shape brackets 22. Such fasteners may include but are not limited to binding members 24 that may include front strips and rear strips between which the mud flaps 20 are sandwiched between and secured using a commercially available fasteners 20A such as, for example, bolts and nuts, snap closures, adhesive, thermal seaming, or magnetic clasps. This ensures a durable and adjustable attachment, allowing customization based on the user's preferences.

The invention includes dampening spacers 30 for providing multiple performance advantages including a snug fit and attenuating movement, vibration and noise emitted from movement and friction between abutted coextensive surfaces of fasteners 36 and aligned side holes 6A and proximate surfaces of opposed flanges 6 and side flanges 28. Dampening spacers 30 as shown in the exemplary embodiments are configured as a flat tab wherethrough two circular holes with ringed lips 32 are configured for simultaneous insertion of ringed lips 32 within a corresponding two pairs of the multiple pairs of aligned side holes 6A so as to impart a snug fit and attenuate movement of fasteners 36 within aligned side holes 6A. As best illustrated in FIGS. 3, 6 and 7, coupling of fasteners 36 through side holes 6A flanked by corresponding fastener holes 28A secures dampening spacers 30 between side flanges 28 and opposed flanges 6 to thereby dampen or attenuate movement and associated noise emitted by contact and vibrations between abutted components when in use.

In alternative embodiments, dampening spacers 30 may be configured as semi-rigid ring members or inserts for side holes 6A or fastener holes 28A. In alternative embodiments, fasteners may be configured as U-pins or cotter pins or any fastening mechanism ensuring a secure and stable connection between the respective components.

It can be readily seen that alternative embodiments may include single components particularly amenable to after-market applications for replacement of damaged or lost components. For example, inventive subject matter includes a single L-shape bracket 22, a single receiving tube 28, and a single mud flap 40.

It is expressly understood that the descriptive exemplary embodiment is provided for explanatory purposes only and is not meant to unduly limit the invention described and claimed herein. Modifications providing further applications for mounting vehicle accessories could facilitate adaptations for use with various carriers, hazard deterring and tow hitch configurations considered within the scope of embodiments of this invention.

1. A mud flap mounting assembly for attachment to a tow hitch channel on a rear of a vehicle, wherein the tow hitch channel includes a plurality of vertically spaced through holes and a recessed channel disposed between a pair of perpendicularly opposed flanges having at least one pair of aligned side holes configured for coupled engagement with at least one of the plurality of vertically spaced through holes at a selected height, the mud flap mounting assembly comprising:
a pair of inverted L-shape brackets having a leg portion with a lower end and an upper end configured for parallel longitudinal alignment with the plurality of vertically spaced through holes of the tow hitch channel and having an arm portion transversely disposed from the upper end of the leg portion, wherein the arm portion and the leg portion are integrally affixed at a substantially perpendicular angle and the arm portion is configured for receiving a pair of corresponding mud flaps;
a pair of receiving tubes configured for coupled seating of a section of the leg members proximal to the lower end, wherein a side flange extends from a contiguous plane extended from a side wall of each of the pair of receiving tubes, and wherein the side flange has at least one fastener hole configured for aligned correspondence with at least one pair of the multiple aligned pairs of side holes in the opposed flanges; and
at least one fastener configured for coupling the at least one fastener hole of the pair of side flanges of the receiving tubes with at least one of the plurality of vertically spaced through holes of the opposed flanges to thereby secure the mud flap mounting assembly to the tow hitch channel.

2. The mud flap assembly of claim 1, wherein the leg portion and the arm portion are disposed in stationary alignment on a single cross-sectional, Cartesian plane.

3. The mud flap assembly of claim 1, further comprising a pair of mud flaps adjoined along at least a portion of an upper edge to corresponding portions of each of the arm portions of the pair of inverted L shape brackets such that the pair of mud flaps are downwardly disposed.

4. The mud flap assembly of claim 3, further comprising a pair of binding members having a front side and a rear side disposed about at least a portion of the pair of arm members such that at least a portion of an upper edge of each of the pair of mud flaps is bound between the front side and the rear side of each of the pair of binding members.

5. The mud flap assembly of claim 4, further comprising a plurality of spaced fasteners affixing the at least a portion of the upper edge of each of the pair of mud flaps to the binding members.

6. The mud flap assembly of claim 5, wherein the spaced fasteners include an adhesive, a thermal seam, a plurality of snap closures or a magnetic clasp.

7. The mud flap assembly of claim 5, wherein the spaced fasteners are a plurality of bolts and corresponding nuts.

8. The mud flap mounting assembly of claim 1, further comprising a pair of dampening spacers configured for insertion within the at least one pair of the multiple pairs of aligned side holes.

9. The mud flap mounting assembly of claim 8, wherein the dampening spacers includes planar tab portion with at least one circular hole ringed by a lip, wherein the lip is configured for insertion within the at least one of the multiple pairs of aligned side holes.

10. The mud flap mounting assembly of claim 9, wherein the at least one circular hole comprises at least two circular holes spaced for simultaneous insertion of the lips within a corresponding two pairs of the multiple pairs of aligned side holes.

11. The mud flap mounting assembly of claim 10, wherein the fastener comprises a U pin with parallel elongate ends configured for simultaneous coupling with a corresponding two pairs of the multiple pairs of aligned side holes.

12. The mud flap mounting assembly of claim 10, wherein the fastener comprises two elongate pins configured for simultaneous coupling with a corresponding two pairs of the multiple pairs of aligned side holes.

13. The mud flap mounting assembly of claim 12, wherein the two elongate pins are bolts with threaded ends having corresponding nuts configured such that coupling of the corresponding nuts with the threaded ends secures the bolts against the opposed flanges of the tow hitch channel mount.

14. A mud flap mounting system for attachment to a tow hitch shank mount configured for coupled engagement with at least one pair of aligned side holes on opposed flanges disposed on a rear surface opposite a receiver end of a tow receiver member, the mud flap mounting system comprising:
a pair of inverted L-shape support members having a leg portion with a lower end and an upper end disposed in parallel longitudinal alignment with the tow hitch shank mount and an arm portion integrally extended at a substantially perpendicular angle from the upper end of the leg portion;
a pair of receiving members configured for coupling a lower section proximal to the lower end of each of the pair of leg members, wherein a side flange extends at a substantially perpendicular angle from at least a portion of a sidewall of each of the pair of receiving members, and wherein the side flange includes at least a pair of fastener holes configured for aligned correspondence with two pairs of the multiple aligned pairs of side holes in the opposed flanges;
a pair of fasteners configured for coupling the pair of fastener holes of each of the receiving members and a corresponding two pairs of the multiple aligned pairs of side holes of the opposed flanges to thereby secure the inverted L-shape support members against the tow hitch channel mount; and
a pair of mud flaps, wherein at least a portion of an upper edge of each of the pair of mud flaps is attached to a corresponding portion of each of the pair of arm members by a plurality of spaced fasteners such that the mud flaps are downwardly disposed.

15. The mud flap mounting assembly of claim 14, further comprising a pair of dampening spacers, each including a planar tab portion with two circular holes ringed with lips spaced for simultaneous insertion of the lips within the two pairs of the multiple aligned pairs of side holes such that the planar tab portion interfaces a coextensive abutted portions of the side flange and the opposed flange and the lip portion interfaces a coextensive abutted portion of the pair of fasteners and the two pairs of the corresponding multiple aligned pairs of side holes.

16. The mud flap assembly of claim 14, wherein the pair of fasteners are bolts and corresponding nuts.

17. The mud flap mounting system of claim 15, wherein the leg portion and arm portion are disposed in stationary alignment on a single cross-sectional, Cartesian plane.

18. A mud flap mounting assembly for attachment to a tow hitch mount perpendicularly affixed to a shank tube for coupling to a corresponding receiver end on a rear of a vehicle, the tow hitch mount having multiple through holes configured for coupled engagement with a receiving hole of a tow receiver member, the mud flap mounting assembly comprising:
at least one inverted L-shape bracket having a leg portion with a lower end and an upper end configured for parallel longitudinal alignment with the tow hitch mount and an arm portion perpendicularly extended from an upper end of the leg portion, wherein at least a lower section of the leg portion of the L-shape bracket is configured for coupled seating of at least a lower section of the leg portion of the inverted L-shape bracket;
at least one side flange extended from the receiving tube, wherein the side flange has at least one fastener hole configured for aligned correspondence with at least one pair of the multiple aligned pairs of side holes; and
at least one mud flap, wherein at least a portion of an upper edge of the mud flap is attachable to a corresponding portion of the arm portion of the at least one inverted L-shape bracket.

19. The mud flap mounting assembly of claim 18, wherein the leg portion and arm portion are disposed in stationary alignment on a single cross-sectional, Cartesian plane.

20. The mud flap mounting assembly of claim 18, wherein the at least one inverted L-shape bracket comprises two inverted L-shape brackets, the at least one receiving tube comprises two receiving tubes and the at least one fastener hole are two fastener holes configured for coupling a pair of elongate pins such that coupled engagement of the two elongate pins and the two fastener holes secures the arm portions of the inverted L-shape brackets in opposed parallel alignment.
